(19) United States
(12) Patent Application Publication
(10) Pub. No.: US 2026/0366764 A1
(43) Pub. Date: Nov. 19, 2026

(54) SOLAR ABSORBER

(71) Applicant: EMITEC TECHNOLOGIES GMBH, Lohmar (DE)

(72) Inventors: Sebastian DUNG, Lohmar (DE); Rolf BRÜCK, Lohmar (DE); Peter HIRTH, Lohmar (DE)

(21) Appl. No.: 19/133,838

(22) PCT Filed: Nov. 24, 2023
(86) PCT No.: PCT/EP2023/082923

§ 371 Date: Jun. 23, 2025

(30) Foreign Application Priority Data
Nov. 29, 2022 (DE) 10 2022 212 804.4

(51) Int. Cl. F24S 70/60; F24S 10/40; F24S 70/12

(52) U.S. Cl. CPC F24S 70/60; F24S 10/40; F24S 70/12

(57) ABSTRACT

The invention relates to a solar absorber for use in a solar power plant. The solar absorber has at least one matrix which is received in a casing, and the matrix is made of a plurality of metal foils, wherein first metal foils are configured to be smooth, and second metal foils are configured to be at least partly structured. The metal foils are stacked one on top of the other, and a plurality of flow channels through which a fluid can flow along a main flow direction from a gas inlet side to a gas outlet side are formed between the metal foils. The casing is attached to a funnel to which a connection tube is attached, and a fluid can flow to the connection tube through the flow channels along the funnel.

A solar absorber is a device designed to be irradiated with (concentrated) sunlight so that it is exposed to considerable thermal stress when used in a solar power plant. The solar absorber can absorb part of the heat thus obtained.

The device provided for this purpose has at least one matrix which is accommodated in a sheath tube or housing. The matrix is formed with a plurality of metal foils, wherein first metal foils are (essentially) smooth and second metal foils are at least partially structured. These metal foils can be stacked on top of each other and form between them a plurality of flow channels through which gas can flow along a main flow direction from a gas inlet side to a gas outlet side.

In the field of solar thermal power plants, especially in plants that use so-called air receiver technology, solar absorbers with volumetric receivers made of silicon carbide (Si—SiC) are used. The solar absorbers have a porous structure that allows air to flow through, forming a plurality of preferably rectangular or square flow channels. The porosity of the state of the art is approximately 80 cells per square inch (cpsi). The material wall thickness of the webs between the individual flow channels is approximately 0.75 mm. The absorber is preferably inserted into a funnel with a connecting pipe made of silicon carbide and connected to it. The flow channels run in a horizontal and vertical arrangement. By focusing an energy source, for example a highly concentrated beam of light, a medium flowing in the flow channels can be heated, thereby generating energy.

A particular disadvantage of the solutions in the prior art is that the flow channels in the edge area are generally less well traversed by the flow, which can lead to increased temperatures in this area, which can also lead to local overheating, which can damage and even cause the absorber to fail.

Another disadvantage is that, due to the materials used and the large temperature difference between the absorber and the support tube, there is a risk that entire absorber modules may slip off. To counteract this phenomenon, a completely circumferential air gap is formed around the absorbers at regular intervals. The air gap results in a loss of potentially usable absorber surface area, which cannot therefore be utilized. This is particularly relevant because known solar thermal systems sometimes contain several tens of thousands of absorbers, which means that the proportion of unused absorber surface area due to the air gap is considerable.

The silicon carbide used is particularly sensitive to thermal shocks. However, large temperature fluctuations, for example due to cloud cover, are to be expected in particular in everyday use. In particular, the material does not allow any elastic deformation, which is why it can be permanently damaged under severe thermal stress fluctuations.

Therefore, the object of the present invention is to at least partially solve the problems described with reference to the prior art and, in particular, to provide a device or solar absorber which is improved in terms of its temperature resistance and/or has a more advantageous thermal conductivity.

The object with regard to the solar absorber is solved by a solar absorber with the features of claim 1. Advantageous further developments are specified in the dependent claims. The features listed individually in the claims can be combined with each other and/or with features of the description in any manner. The description, in particular in connection with the figures, explains the invention and specifies additional embodiments.

This is achieved by a device, referred to here as a solar absorber, for use in a solar power plant, wherein the solar absorber comprises at least one matrix which is accommodated in a sheath housing. The matrix is formed from a plurality of metal foils, wherein first metal foils are smooth and second metal foils are at least partially structured. The metal foils are stacked on top of each other and form between them a plurality of flow channels through which a fluid can flow along a main flow direction from a gas inlet side to a gas outlet side. The sheath housing is connected to a funnel to which a connecting pipe is connected, wherein a fluid can flow through the flow channels along the funnel to the connecting pipe.

The structure and shape of the solar absorber can be easily adapted to the boundary conditions with regard to the installation space of the receiver of the solar power plant. The solar absorber has particularly preferably a square cross-section, but other designs such as rectangular, oval, or hexagonal designs are also possible. The intended sheath housing has essentially the same cross-section as the matrix, i.e., it is also square, rectangular, or hexagonal. The sheath housing can also be designed as a sheath tube.

In particular, the matrix is designed to be adjacent to or directly connected to the sheath housing, i.e., in particular without a circumferential (but not axially permeable) air gap. In other words, this means in particular that the flow channels are provided up to the point adjacent to the sheath housing; consequently, there are no (separate or additional) cooling channels between the matrix and the sheath housing. Consequently, the entire inner cross-section of the sheath housing can be used as an absorber for solar (frontal) energy input.

The matrix can be partially inserted into the sheath housing or arranged so that it protrudes into it. In particular, the sheath housing only partially covers the matrix, namely in a matrix section facing the funnel. The matrix section enclosed by the sheath housing can be approximately half the axial length of the matrix. In particular, the sheath housing is designed with a smaller axial length than the funnel and/or the connecting pipe. The sheath housing can be configured as a single piece with the funnel. The funnel and the connecting pipe can be configured as a single piece. The sheath housing, funnel, and/or connecting pipe can be configured separately and joined together.

The solar absorber forms a ready-to-install unit with the funnel and the connecting pipe. Several of these solar absorbers are assembled (adjacent or in a plane) and together form the solar power plant. The size of the solar power plant can be scaled according to the number of solar absorbers.

The entire irradiated surface formed by the respective gas inlet side of the solar absorber (or the matrix) is flowed through (axially), thus ensuring ideal utilization of the installation space, which increases overall efficiency. The gas inlet side forms the entrance to the many flow channels formed by the matrix. By irradiating this surface with concentrated light, the gas inlet side and subsequently the entire matrix are heated up significantly. The heat energy can be transferred from the heated matrix to a medium flowing through the flow channels, for example air. The heat energy bound in the air flowing through the flow channels can ultimately be used to generate electricity.

The surrounding air gap, which exists in state-of-the-art systems, can be reduced or eliminated entirely. This can be achieved by placing directly adjacent matrices with their sheath housings directly against each other so that air cannot flow past the matrices. This improves the efficiency of the system.

The thin first and second metal foils (particularly compared to the sheath housing) have very good axial and radial heat conduction properties, which enables particularly homogeneous and rapid heating of the matrix. In particular, the formation of so-called hot spots can be avoided. The matrix formed from the metal foils also offers a certain degree of flexibility, as the foils can move relative to each other to a certain extent and the entire matrix can expand or contract. This allows stresses to be absorbed, which can arise as a result of thermal shocks, for example.

The matrix is preferably made of alternating (metallic) corrugated layers and smooth layers, which are stacked on top of each other, inserted into the sheath housing, and connected to it. The matrix preferably has a cell density of 80 cpsi to 1600 cpsi (cells per square inch), particularly preferably a cell density of 200 cpsi to 800 cpsi, and most preferably of 500 cpsi to 700 cpsi.

Due to the very low wall thickness of the metallic foils, even at low cell densities and thus a high porosity of the matrix, a large geometric surface area is achieved compared to state-of-the-art systems, thereby increasing the efficiency. The foils used preferably have a thickness of 20 μm to 250 μm [micrometers], particularly preferably from 30 μm to 100 μm, and most preferably from 50 μm to 80 μm.

The solar-weighted absorptivity is between 95% and 96%, and the thermal efficiency is approximately 90% at a temperature of 700 degrees Celsius and a flux density of 641 kW/m². This corresponds to an improvement in absorptivity of 5% and an improvement in thermal efficiency of 6% to 7% compared to solutions known from the prior art.

During operation, the absorber or the metallic foils form a protective dark oxide layer which, in addition to protecting the metal foils, also increases the absorptivity, thereby improving the thermal efficiency.

It is particularly advantageous if the sheath housing has a shorter (axial) extension along the main flow direction than the matrix. The sheath housing is shorter than the matrix itself along the main flow direction of the matrix. This means that the matrix protrudes beyond the sheath housing. The sheath housing is thus set back behind the gas inlet side formed by the matrix so that it lies in an area shaded by the matrix. By arranging several solar absorbers directly adjacent to each other, the sheath housing is not directly exposed to concentrated light. This reduces the possibility of damage to the sheath and actively prevents deformation of the sheath housing. The shortening of the sheath housing relative to the matrix on the gas inlet side is preferably in a range between 0% and 90%, particularly preferably in a range between 20% and 80%, and most preferably in a range between 30% and 70%.

It is also advantageous if a corrugated third metal foil is arranged between the matrix and the sheath housing, which has a significantly larger structure than the second metal foils. The third metal foil can also be part of the matrix itself. Structuring can be characterized by a wavelength and a wave height, such that the wavelength and/or wave height of the corrugated third metal foil is/are greater than that of the first and second metal foils in the inner or inner adjacent region of the matrix.

The third metal foil has a structure, in particular a corrugation. The third metal foil is arranged circumferentially around the matrix or as an edge region of the matrix and thus forms further (axially flowable) flow channels between the sheath housing and the (inner) matrix. The porosity in the region of the third metal foil is significantly higher because the cell density is lower due to the stronger structuring. The high porosity in the area of the third metal foil increases the flexibility of the matrix package, especially under thermal shock loads. In addition, the matrix cools down more quickly and more strongly in the area close to the sheath due to the higher flow rate resulting from the generally lower counterpressure in this area. The sheath temperature is thus quickly reduced or maintained at a lower level, which reduces deformation of the sheath and thus prevents damage.

Furthermore, the circumferential position of the third metal foil improves the bonding quality of the matrix to the sheath, especially on the vertical sides where the foil edges meet the sheath. The foil thickness of the third metal foil, which forms the so-called compensation layer, is preferably 20 μm to 250 μm [micrometers], particularly preferably between 50 μm and 150 μm, and most preferably between 80 μm and 120 μm.

The matrix is firmly connected to the third metal foil or compensation layer. The sheath housing is shorter so that the matrix and the compensation layer protrude beyond the sheath housing on the gas inlet side.

The corrugated third metal foil can be wound around the matrix in the circumferential direction and form flow channels between the matrix and the sheath housing, which run parallel to the main flow direction.

The first metal foils may have a shorter extension along the main flow direction of the matrix than the second metal foils. The shortened first metal foils, which are the smooth metal foils, create a porosity which is higher in the area of the shortened first metal foils than in the rest of the matrix.

The first metal foils can be flush with the second metal foils on the gas outlet side and the first metal foils can be arranged set back relative to the second metal foils on the gas inlet side in the main flow direction. This increases the porosity at the gas inlet in particular. As a result, more radiant energy can be absorbed. This applies in particular to energy originating from radiation that strikes the gas inlet side of the absorber at an angle. This increases the thermal efficiency.

The inlet section refers to the section of the matrix that has increased porosity due to the shortened first metal foil. The length of this inlet section is preferably 0 mm to 40 mm [millimeters], particularly preferably 2 mm to 20 mm, and especially preferably 5 mm to 10 mm.

The matrix can protrude beyond the sheath housing with its gas inlet side. This increases the porosity, particularly in the area primarily irradiated by the concentrated radiation, which promotes heating of the matrix and thus increases the efficiency.

It may also be advantageous to arrange several matrices one behind the other along the main flow direction. Each of the matrices can have a different cell density and thus a different porosity. By cascading the individual matrices once or several times over the length of the absorber, it is possible to achieve axial areas of different porosity in the absorber, so that the absorber can be designed specifically for optimum efficiency. High porosity in the area of the gas inlet side is particularly advantageous in this case.

Furthermore, it is advantageous if the matrix forming the gas inlet side has shorter first metal foils than the second metal foils.

According to a further aspect, the use of a solar absorber of the type presented here is proposed for improving the solar-weighted absorptivity and/or the thermal efficiency of a solar power plant. For further details on the use, reference can be made in full to the application specifications and/or effects or advantages described.

The invention and its context are explained in detail below with reference to the schematic drawings and examples of embodiments. It should be noted that elements designated by the same reference signs in the drawings may have the same properties, unless explicitly stated otherwise here. The elements illustrated in the drawings may be further characterized by features from other drawings and/or the description and/or the claims (and vice versa), unless explicitly excluded below. The drawings show:

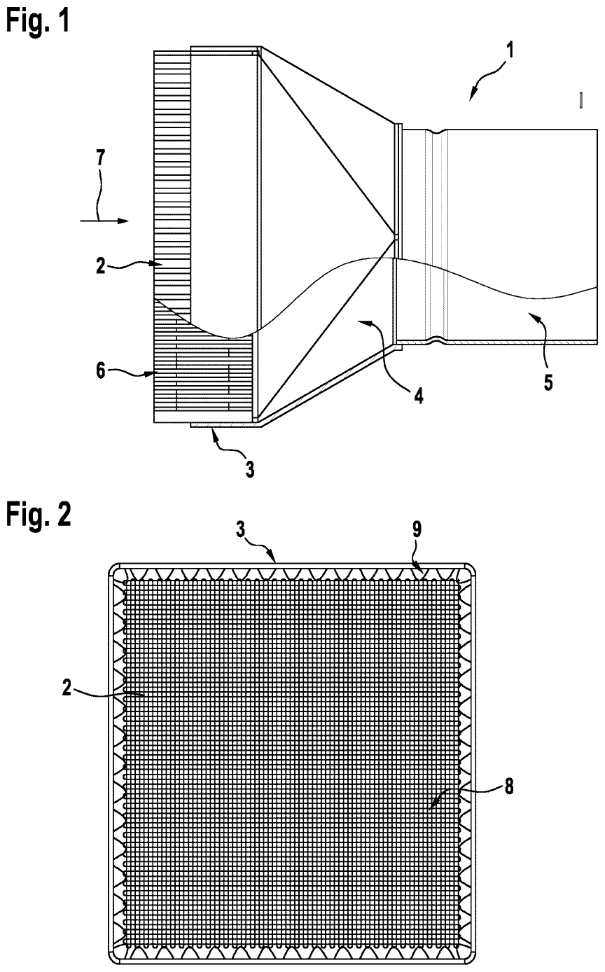

FIG. 1 a sectional view through an absorber with a matrix housed in a sheath housing and a connected funnel and a connecting pipe, and

FIG. 2 a top view of a matrix with a compensation layer running circumferentially between the matrix and the sheath housing.

FIG. 1 shows a sectional view through a solar absorber 1. The solar absorber has a matrix 2 which is held in a sheath housing 3. The sheath housing 3 is connected to a funnel 4, and the connecting pipe 5 is connected to the funnel 4.

The matrix 2 forms a gas inlet side 6, which protrudes beyond the sheath housing 3 along the main flow direction 7. FIG. 1 does not show how the first metal foils, the smooth layers, are shorter than the second metal foils, the corrugated layers, thus creating increased porosity in the area of the gas inlet side 6. In other words, the smooth layers do not extend to the gas inlet side 6, but extend, for example, into an (axial) area between the frontal edges of the corrugated layers and the sheath housing 5.

Air can flow through the solar absorber 1 along the flow channels in the matrix 2 to the funnel 4 and finally to the connecting pipe 5, whereby the air absorbs heat energy from the matrix 2 and is thus heated.

FIG. 2 shows a top view of the gas inlet side 6 of the matrix 2. It can be seen that the matrix 2 forms a plurality of flow channels 8, which are created between the first metal foils and the second metal foils. The cell density in the area of the matrix 2 is thus high in comparison to the cell density produced by the third metal foil 9 between the matrix 2 and the sheath housing 3. The third metal foil 9 runs in the circumferential direction around the matrix 2 and has a much coarser structure than the second metal foils of the matrix, which are at least partially structured.

The embodiments shown in FIGS. 1 and 2 are not intended to be limiting and serve only to illustrate the concept of the invention.

### LIST OF REFERENCE SIGNS

1. Solar absorber
2. Matrix
3. Sheath housing
4. Funnel
5. Connecting pipe
6. Gas inlet side
7. Main flow direction
8. Flow channels
9. Third metal foil

1-10. (canceled)

11. A solar absorber for use in a solar power plant, the solar absorber comprising:
a sheath housing;
at least one matrix accommodated in said sheath housing, said at least one matrix formed from a plurality of metal foils, wherein said metal foils include first metal foils which are smooth and second metal foils which are at least partially structured, wherein said metal foils are stacked on top of one another and a plurality of flow channels is formed between said metal foils, through said flow channels a flow is possible along a main flow direction from a gas inlet side to a gas outlet side;
a funnel connected to said sheath housing; and
a connecting pipe connected to said funnel, wherein a fluid can flow through said flow channels along said funnel to said connecting pipe.

12. The solar absorber according to claim 11, wherein said sheath housing has a shorter extension along the main flow direction than said at least one matrix.

13. The solar absorber according to claim 11, further comprising a corrugated third metal foil disposed between said at least one matrix and said sheath housing, said corrugated third metal foil having a stronger structure than said second metal foils.

14. The solar absorber according to claim 13, wherein said corrugated third metal foil is wound around said at least one matrix in a circumferential direction and forms said flow channels between said at least one matrix and said sheath housing, which run parallel to the main flow direction.

15. The solar absorber according to claim 11, wherein said first metal foils have a shorter extension along the main flow direction of said at least one matrix than said second metal foils.

16. The solar absorber according to claim 15, wherein said first metal foils are flush with said second metal foils on the gas outlet side and said first metal foils are disposed set back relative to said second metal foils on the gas inlet side in the main flow direction.

17. The solar absorber according to claim 11, wherein said at least one matrix protrudes beyond said sheath housing with said gas inlet side.

18. The solar absorber according to claim 11, wherein said at least one matrix is one of a plurality of matrices disposed one behind another along the main flow direction.

19. The solar absorber according to claim 18, wherein said matrix forming said gas inlet side has said first metal foils being shorter than said second metal foils.

20. A method of using a solar absorber, which comprises the step of:
providing the solar absorber according to claim 11 which improves a solar-weighted absorptivity and/or a thermal efficiency of the solar power plant.
